(19) United States
(12) Patent Application Publication
(10) Pub. No.: US 2025/0356005 A1
(43) Pub. Date: Nov. 20, 2025

(54) TECHNOLOGIES FOR AUTOMATED PREDICTIVE CURATION OF CONTEXTUALIZATION STEPS FOR INVESTIGATING A SECURITY INCIDENT

(71) Applicant: Arctic Wolf Networks, Inc., Eden Prairie, MN (US)

(72) Inventors: Hazem Mohamed Ahmed Soliman, Toronto (CA); Jeffrey Martin Green, Brentwood, TN (US); Syed Azfar Hussain, Nepean (CA); Jonathan Fernandez Sallot, Boerne, TX (US); Marcio Lopes Larroyd, Kitchener (CA); Zaahid Muhammad, Minneapolis, MN (US); Ramesh Rapelly, Atlanta, GA (US); Warren Christopher Gray, Kitchener (CA); Dean Whitney Teffer, Austin, TX (US); Kenneth D. Ray, Enumclaw, WA (US); Michael Elliott Mylrea, Delray Beach, FL (US); Bryan William Alexander Guscott, Calgary (CA)

(21) Appl. No.: 19/206,337

(22) Filed: May 13, 2025

Related U.S. Application Data
(60) Provisional application No. 63/647,118, filed on May 14, 2024.

(51) Int. Cl. G06F 21/55

(52) U.S. Cl. CPC G06F 21/554; G06F 2221/034

(57) ABSTRACT

Technologies for automated security incident analysis include a computing device that clusters security incidents and runbooks into multiple clusters based on investigation similarity. For each cluster, the computing device determines a summary of all security incidents in the cluster with a large language model, determines criteria for inclusion of a security incident in the cluster, and determines a suggested investigation step with a retrieval augmented generation pipeline. The suggested investigation step includes a natural language description and a programmatic query. Upon receiving approval from a user, the computing device stores the cluster information in a curated query repository. The computing device may receive a security incident for investigation, assign the security incident to a cluster based on the stored criteria, and retrieve a suggested investigation step from the curated query repository. The computing device may provide the suggested investigation step to a user. Other embodiments are described and claimed.

### CROSS-REFERENCE TO RELATED APPLICATION

This application claims priority to U.S. Provisional Application Ser. No. 63/647,118, filed May 14, 2024, the entire disclosure of which is hereby incorporated by reference.

### BACKGROUND

As computers and computer networks become ubiquitous throughout industry and society, computer security has become increasingly important. At the same time, computer security threats have increased in number and, potentially, in severity. Typical systems may monitor computer networks and devices for potential malicious activity or other security incidents. Currently, when a potential security incident is detected, a human analyst investigates the incident to determine whether further action is warranted. The analyst may use his or her domain knowledge and training to determine how to investigate the incident.

In a typical investigation by a human analyst, each investigation starts with the security event itself. Each security incident is handled as a singular event, meaning that the analyst must build context for the security event from scratch. Accordingly, determining investigation steps for each new security event may be a difficult and labor-intensive process.

### SUMMARY

According to one aspect of the disclosure, a computing device for security incident analysis comprises an incident clustering engine, a cluster summarizer, a cluster criteria manager, a retrieval augmented generation pipeline, an investigation step engine, and a curation manager. The incident clustering engine is to cluster a plurality of security incidents and runbooks into a plurality of clusters based on investigation similarity associated with the plurality of security incidents and the runbooks. The cluster summarizer to determine a summary of each cluster in the plurality of clusters based on the security incidents of the cluster with a large language model. The cluster criteria manager is to determine one or more criteria for inclusion of a security incident in each cluster of the plurality of clusters. The retrieval augmented generation pipeline is to access one or more retrieval sources for contextual awareness. The investigation step engine is to determine a suggested investigation step for each cluster of the plurality of clusters with the retrieval augmented generation pipeline, wherein each suggested investigation step comprises a natural language description and a programmatic query of a security incident data store. The curation manager is to receive an approval of the summary, the one or more criteria, and the suggested investigation step for each cluster of the plurality of clusters from a user. The curation manager is further to store the summary, the one or more criteria, and the suggested investigation step for each cluster of the plurality of clusters in a curated query repository of the computing device in response to receipt of the approval. In an embodiment, the curation manager is further to perform reinforcement learning with human feedback based on a security incident resolution.

In an embodiment, each security incident of the plurality of security incidents comprises a record including a plurality of fields that are indicative of a detected computer security incident or a detected network security incident characterized by anomaly detection thresholds.

In an embodiment, the computing device further comprises an investigation manager to receive a first security incident, wherein the security incident comprises a plurality of fields indicative of a potential security detection at a monitored computer system or network; assign the first security incident to a first cluster of the plurality of clusters based on the one or more criteria for inclusion of the security incident in each cluster of the plurality of clusters; and retrieve a first suggested investigation step for the first cluster, wherein the first suggested investigation step was determined by the retrieval augmented generation pipeline for the first cluster. In an embodiment, the computing device further comprises an investigation interface to present the first security incident and the first suggested investigation step to a user. In an embodiment, the investigation interface is further to receive a security incident resolution from the user.

In an embodiment, to cluster the plurality of security incidents and runbooks comprises to generate an embedding for each security incident of the plurality of security incidents and for each runbook; identify the embedding associated with each runbook as a centroid of a corresponding cluster; and compare the embedding associated with each security incident to each of the centroids to determine an associated investigation similarity. In an embodiment, to compare the embedding associated with each security incident to each of the centroids comprises to determine a distance between the embedding associated with each security incident and each centroid and to compare the distance to a predetermined similarity threshold distance.

In an embodiment, investigation similarity comprises vector similarity metrics and semantic proximity. In an embodiment, to cluster the plurality of security incidents and runbooks comprises to determine a natural language description of investigation steps for each security incident with a large language model; generate a vector embedding for the natural language description of investigation steps for each security incident of the plurality of security incidents; and determine investigation similarity based on the vector embedding associated with the natural language description of each security incident. In an embodiment, to determine the natural language description of the investigation steps comprises to prompt the large language model with a description field associated with each security incident.

In an embodiment, to cluster the plurality of security incidents and runbooks comprises to determine a label for each security incident of the plurality of security incidents, wherein the label comprises a benign label or a malicious label; train a plurality of classification models on the labels associated with each of the plurality of security incidents; and determine investigation similarity based on similarity of classification model. In an embodiment, the classification model comprises a decision tree model.

In an embodiment, to determine the one or more criteria for inclusion of a security incident in the cluster comprises to identify a high granularity field of the plurality of security incidents; and match against values of the high granularity field for the plurality of security incidents in the cluster. In an embodiment, to determine the one or more criteria for inclusion of a security incident in the cluster comprises to determine fields of the plurality of security incidents having a high divergence between first security incidents in the cluster and second security incidents outside of the cluster; and match against values of the fields having the high divergence. In an embodiment, to determine the fields of the plurality of security incidents having the high divergence comprises to determine a first distribution of values for a field for first security incidents in the cluster and a second distribution of values for the field for second security incidents outside of the cluster; and determine a Kullback-Leibler divergence between the first distribution and the second distribution. In an embodiment, to determine the one or more criteria for inclusion of a security incident in the cluster comprises to train a machine learning classifier to classify between first security incidents in the cluster and second security incidents outside of the cluster.

In an embodiment, to determine the suggested investigation step for the cluster with the retrieval augmented generation pipeline comprises to determine the natural language description with a runbook of the cluster as a retrieval source of the retrieval augmented generation pipeline. In an embodiment, to determine the suggested investigation step for the cluster with the retrieval augmented generation pipeline comprises to determine the programmatic query with a schema of the security incident data store as a retrieval source of the retrieval augmented generation pipeline.

According to another aspect, a method for security incident analysis comprises clustering, by a computing device, a plurality of security incidents and runbooks into a plurality of clusters based on investigation similarity associated with the plurality of security incidents and the runbooks; and for each cluster in the plurality of clusters: determining, by the computing device, a summary of the cluster based on the security incidents of the cluster with a large language model; determining, by the computing device, one or more criteria for inclusion of a security incident in the cluster; accessing, by the computing device, one or more retrieval sources for contextual awareness with a retrieval augmented generation pipeline of the computing device; determining, by the computing device, a suggested investigation step for the cluster with the retrieval augmented generation pipeline, wherein the suggested investigation step comprises a natural language description and a programmatic query of a security incident data store; receiving, by the computing device, an approval of the summary, the one or more criteria, and the suggested investigation step from a first user; and storing, by the computing device, the summary, the one or more criteria, and the suggested investigation step in a curated query repository of the computing device in response to receiving the approval. In an embodiment, the method further comprises performing, by the computing device, reinforcement learning with human feedback based on a security incident resolution.

In an embodiment, each security incident of the plurality of security incidents comprises a record including a plurality of fields that are indicative of a detected computer security incident or a detected network security incident characterized by anomaly detection thresholds.

In an embodiment, the method further comprises receiving, by the computing device, a first security incident, wherein the security incident comprises a plurality of fields indicative of a potential security detection at a monitored computer system or network; assigning, by the computing device, the first security incident to a first cluster of the plurality of clusters based on the one or more criteria for inclusion of the security incident in each cluster of the plurality of clusters; and retrieving, by the computing device, a first suggested investigation step for the first cluster, wherein the first suggested investigation step was determined by the retrieval augmented generation pipeline for the first cluster. In an embodiment, the method further comprises presenting, by the computing device, the first security incident and the first suggested investigation step to a user. In an embodiment, the investigation interface is further to receive a security incident resolution from the user.

In an embodiment, investigation similarity comprises vector similarity metrics and semantic proximity. In an embodiment, clustering the plurality of security incidents and runbooks comprises generating a vector embedding for each security incident of the plurality of security incidents and for each runbook; identifying the vector embedding associated with each runbook as a centroid of a corresponding cluster; and comparing the vector embedding associated with each security incident to each of the centroids to determine an associated investigation similarity. In an embodiment, comparing the embedding associated with each security incident to each of the centroids comprises determining a distance between the embedding associated with each security incident and each centroid and comparing the distance to a predetermined similarity threshold distance.

In an embodiment, clustering the plurality of security incidents and runbooks comprises determining a natural language description of investigation steps for each security incident with a large language model; generating an embedding for the natural language description of investigation steps for each security incident of the plurality of security incidents; and determining investigation similarity based on the embedding associated with the natural language description of each security incident. In an embodiment, determining the natural language description of the investigation steps comprises prompting the large language model with a description field associated with each security incident.

In an embodiment, clustering the plurality of security incidents and runbooks comprises determining a label for each security incident of the plurality of security incidents, wherein the label comprises a benign label or a malicious label; training a plurality of classification models on the labels associated with each of the plurality of security incidents; and determining investigation similarity based on similarity of classification model. In an embodiment, the classification model comprises a decision tree model.

In an embodiment, determining the one or more criteria for inclusion of a security incident in the cluster comprises identifying a high granularity field of the plurality of security incidents; and matching against values of the high granularity field for the plurality of security incidents in the cluster. In an embodiment, determining the one or more criteria for inclusion of a security incident in the cluster comprises determining fields of the plurality of security incidents having a high divergence between first security incidents in the cluster and second security incidents outside of the cluster; and matching against values of the fields having the high divergence. In an embodiment, determining the fields of the plurality of security incidents having the high divergence comprises determining a first distribution of values for a field for first security incidents in the cluster and a second distribution of values for the field for second security incidents outside of the cluster; and determining a Kullback-Leibler divergence between the first distribution and the second distribution. In an embodiment, determining the one or more criteria for inclusion of a security incident in the cluster comprises training a machine learning classifier to classify between first security incidents in the cluster and second security incidents outside of the cluster.

In an embodiment, determining the suggested investigation step for the cluster with the retrieval augmented generation pipeline comprises determining the natural language description with a runbook of the cluster as a retrieval source of the retrieval augmented generation pipeline. In an embodiment, determining the suggested investigation step for the cluster with the retrieval augmented generation pipeline comprises determining the programmatic query with a schema of the security incident data store as a retrieval source of the retrieval augmented generation pipeline.

According to another aspect, a computing device for security incident analysis comprises an incident clustering engine, a cluster criteria manager, and an investigation step engine. The incident clustering engine is to cluster a plurality of security incidents and runbooks into a plurality of clusters based on investigation similarity associated with the plurality of security incidents and the runbooks. The cluster criteria manager is to determine one or more criteria for inclusion of a security incident in each cluster of the plurality of clusters, wherein each of the one or more criteria comprises explainable logic for assignment of security incidents to the associated cluster. The investigation step engine is to determine a suggested investigation step for each cluster of the plurality of clusters with a retrieval augmented generation pipeline, wherein each suggested investigation step comprises a natural language description and a programmatic query of a security incident data store. In an embodiment, the computing device further comprises a cluster summarizer to determine a summary of each cluster in the plurality of clusters based on the security incidents of the cluster with a large language model. In an embodiment, the computing device further comprises a curation manager. The curation manager is to receive an approval of the summary, the one or more criteria, and the suggested investigation step for each cluster of the plurality of clusters from a first user. The curation manager is further to store the summary, the one or more criteria, and the suggested investigation step for each cluster of the plurality of clusters in a curated query repository of the computing device in response to receipt of the approval.

According to another aspect, a method for security incident analysis includes clustering, by a computing device, a plurality of security incidents and runbooks into a plurality of clusters based on investigation similarity associated with the plurality of security incidents and the runbooks; and for each cluster in the plurality of clusters: determining, by the computing device, one or more criteria for inclusion of a security incident in the cluster, wherein each of the one or more criteria comprises explainable logic for assigning security incidents to the associated cluster; and determining, by the computing device, a suggested investigation step for the cluster with a retrieval augmented generation pipeline, wherein the suggested investigation step comprises a natural language description and a programmatic query of a security incident data store. In an embodiment, the method further includes, for each cluster in the plurality of clusters, determining, by the computing device with a large language model, a summary of the cluster based on the security incidents of the cluster. In an embodiment, the method further includes, for each cluster in the plurality of clusters: receiving, by the computing device, an approval of the summary, the one or more criteria, and the suggested investigation step from a first user; and storing, by the computing device, the summary, the one or more criteria, and the suggested investigation step in a curated query repository of the computing device in response to receiving the approval.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for automated predictive curation of contextualization steps for investigating a security incident;

FIG. 2 is a simplified block diagram of an environment that may be established by a computing device of FIG. 1;

FIGS. 3 and 4 are a simplified flow diagram of at least one embodiment of a method for automated predictive curation of contextualization steps for investigating a security incident that may be executed by the computing device of FIGS. 1 and 2;

FIG. 5 is a simplified flow diagram of at least one embodiment of a method for clustering security incidents that may be executed by the computing device of FIGS. 1 and 2;

FIG. 6 is a simplified flow diagram of at least one embodiment of another method for clustering security incidents that may be executed by the computing device of FIGS. 1 and 2;

FIG. 7 is a simplified flow diagram of at least one embodiment of yet another method for clustering security incidents that may be executed by the computing device of FIGS. 1 and 2;

FIG. 8 is a simplified flow diagram of at least one embodiment of a method for investigating a security incident with curated contextualization steps that may be executed by the computing device of FIGS. 1 and 2;

FIG. 9 is a schematic diagram illustrating one potential embodiment of an investigation user interface that may be provided in connection with the method of FIG. 8; and

FIG. 10 is a schematic diagram that shows an example of a computing system.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

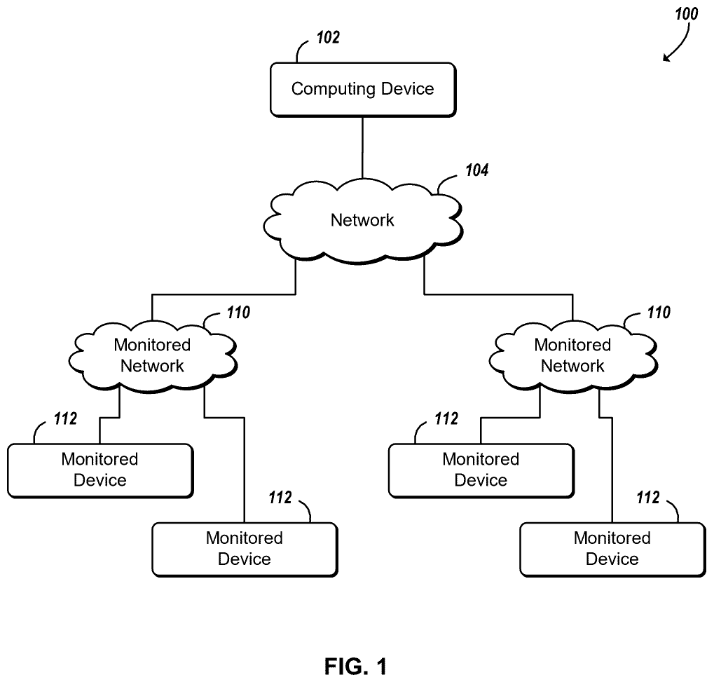

Referring now to FIG. 1, an illustrative system 100 for automated predictive curation of contextualization steps for investigating a security incident includes a computing device 102 in communication over a network 104 with one or more monitored networks 110 and/or monitored devices 112. The computing device 102 is configured to monitor network and system operations performed with the monitored networks 110 and/or monitored devices 112 to identify potential security incidents. Security incidents may include, for example, activity indicative of unauthorized access to computer systems and networks, attempted unauthorized access, potential exploit execution, or other potentially malicious activity. In use, as described further below, in an offline phase the computing device 102 identifies clusters of similarly-investigated security incidents, and using an artificial intelligence system builds a set of suggested investigation steps with associated queries for each cluster. A domain expert or other user approves the suggested investigation steps, which then are stored in a curated queries repository. In an online phase, the computing device 102 assigns each new security incident to a cluster, retrieves the associated approved curated queries, and presents the security incident and the approved queries to an analyst or other user. The analyst may use the approved queries to contextualize the security incident and otherwise investigate the security incident. Thus, the system 100 provides an artificial intelligence human-in-the-loop end-to-end workflow for curating and surfacing contextualization steps for investigating a security incident. By automatically identifying and surfacing contextualization information, the system 100 may provide relevant information regarding a potential security incident more quickly, more consistently, and more accurately as compared to typical, manual investigation processes. Further, by automatically identifying approved queries for a security incident, the system 100 may avoid the need to execute all potential queries on every security incident, which supports scaling to investigating large numbers of security incidents. Additionally, by automating the curation of suggested queries, the system 100 may improve scalability of the system 100 by allowing domain expert knowledge to be employed by multiple analysts with improved accuracy and consistency. Thus, this improved security incident investigation may improve the overall security of the monitored networks 110 and the monitored devices 112.

Thus, the disclosed system 100 may provide a form of inductive reasoning for clustering and responding to previously unobserved security events based on known security events and responses and other domain knowledge. Accordingly, as compared to conventional security incident investigation performed by a human analyst, the disclosed system 100 may provide improved performance by improved clustering to group security events that have similar investigation steps, even for security events that have not been observed previously. Thus, the disclosed system 100 may improve automatic context building for responding to security events.

Similarly, the disclosed techniques can collect and analyze analyst responses to cybersecurity event tickets, and based on that analysis, leverage AI and/or classification techniques to identify value and determine valuable queries to provide analysts for use in responding to the cybersecurity event tickets, which is described further in reference to U.S. patent application Ser. No. ______, entitled REFINING CURATED QUERIES, which was filed on even date herewith, and which is incorporated herein by reference in its entirety. Sometimes, the actions performed for addressing the tickets can be performed through a cybersecurity interface as described in U.S. patent application Ser. No. ______, entitled INTERFACE AND SYSTEM FOR AUTOMATED

REASONING ON SYSTEMIC PARAMETERS OF CYBERSECURITY RESPONSE, which was filed on even date herewith, and which is incorporated herein by reference in its entirety.

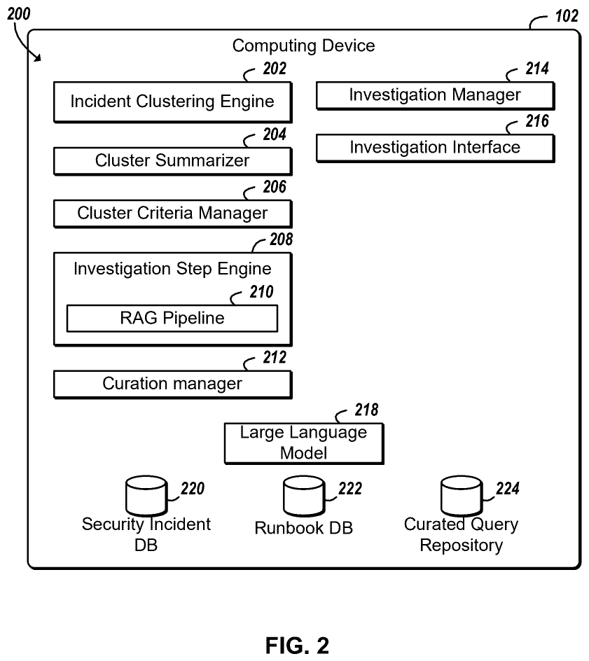

Referring now to FIG. 2, in the illustrative embodiment, the computing device 102 establishes an environment 200 during operation. The illustrative environment 200 includes an incident clustering engine 202, a cluster summarizer 204, a cluster criteria manager 206, an investigation step engine 208, a curation manager 212, an investigation manager 214, and an investigation interface 216. In some embodiments, the environment 200 further includes a large language model (LLM) 218; however in some embodiments the LLM 218 may be hosted or otherwise provided by a remote server or other device. Additionally, although illustrated as including a single LLM 218, it should be understood that in some embodiments the functions of the LLM 218 may be performed by multiple LLMs hosted by the computing device 102 and/or remote devices.

The various components of the environment 200 may be embodied as hardware, firmware, software, or a combination thereof. As such, in some embodiments, one or more of the components of the environment 200 may be embodied as circuitry or a collection of electrical devices (e.g., clustering engine circuitry 202, cluster summarizer circuitry 204, cluster criteria manager circuitry 206, investigation step engine circuitry 208, curation manager circuitry 212, investigation manager circuitry 214, investigation interface circuitry 216, and/or large language model circuitry 218). It should be appreciated that, in such embodiments, one or more of those components may form a portion of the processor, the I/O subsystem, and/or other components of the computing device 102. Additionally, although illustrated as being performed by a single computing device 102, it should be understood that in some embodiments the components of the environment 200 may be distributed among multiple computing devices 102 or otherwise executed by multiple computing devices 102.

The incident clustering engine 202 is configured to cluster security incidents and runbooks into multiple clusters based on investigation similarity. The security incidents may be stored in a security incident database 220, and each security incident may be embodied as one or more records including fields that are indicative of a detected computer security incident or a detected network security incident characterized by anomaly detection thresholds. Similarly, the runbooks may be stored in a runbook database 222 and may be embodied as documentation, standard operating procedures, sample queries, and other information relating to investigation of a particular type of computer or network security incident.

Investigation similarity may comprise one or more vector similarity metrics and semantic proximity. In some embodiments, clustering the security incidents and runbooks includes generating a vector embedding for each security incident and runbook. The vector embedding associated with each runbook is identified as the centroid of a corresponding cluster, and the vector embedding associated with each security incident is compared to each of the centroids to determine an associated investigation similarity. In some embodiments, a distance between the vector embedding associated with each security incident and each centroid may be determined, and the distance may be compared to a predetermined similarity threshold distance.

In some embodiments, clustering the security incidents and runbooks includes determining a natural language description of investigation steps for each security incident with a LLM 218, generating an embedding for that natural language description; and determining investigation similarity based on the embedding associated with the natural language descriptions of each security incident. Clustering the security incidents may further include determining cluster centroids and boundaries based on the embeddings associated with the natural language description with an appropriate clustering algorithm, such as a semi-supervised clustering using the LLM 218. In some embodiments, determining the natural language description of the investigation steps may include prompting the LLM 218 with a description field associated with each security incident or with all fields associated with each security incident in some embodiments.

In some embodiments, clustering the security incidents and runbooks includes determining a label for each security incident. For example, each security incident may be labeled as benign or malicious. Multiple classification models may be trained on those labels, and investigation similarity may be determined based on similarity of the classification models after training. Each classification model may be embodied as, for example, a decision tree.

The cluster summarizer 204 is configured to determine a summary of each cluster in the plurality of clusters based on the security incidents of the cluster with a LLM 218. In some embodiments, the summary for a particular cluster may be based on a description field or other field extracted from every security incident included in that cluster.

The cluster criteria manager 206 is configured to determine one or more criteria for inclusion of a security incident in each cluster of the plurality of clusters. In some embodiments, to determine the one or more criteria includes identifying one or more high granularity fields of the security incidents, and matching against values of each high granularity field of the security incidents included in a cluster. In some embodiments, determining the one or more criteria includes determining fields of the security incidents having a high divergence between security incidents in a cluster and outside of that cluster, and matching against values of the fields having the high divergence. Determining fields having high divergence may include determining distributions of values for fields security incidents in the cluster and outside of the cluster and determining a Kullback-Leibler divergence between those distributions. In some embodiments, determining the one or more criteria includes training a machine learning classifier to classify between security incidents in a cluster outside of the cluster.

The investigation step engine 208 is configured to determine on or more suggested investigation steps for each cluster of the plurality of clusters with a retrieval augmented generation (RAG) pipeline 210. Each suggested investigation step includes a natural language description and a programmatic query of a security incident data store, such as the security incident database 220, an observation data store (which may include more data than the security incident database 220), and/or an external API or other data source. The RAG pipeline 210 accesses one or more retrieval sources to provide contextual awareness. In some embodiments, determining the suggested investigation step includes determining the natural language description with one or more runbooks of the cluster, analyst notes, or other security intelligence information as a retrieval source of the RAG pipeline 210. In some embodiments, determining the suggested investigation step includes determining the programmatic query with a schema of the security incident data store as a retrieval source of the RAG pipeline 210.

The curation manager 212 is configured to receive an approval of the summary, the one or more criteria, and the suggested investigation step for each cluster from a user. The user may be, for example, a domain expert, technical lead, or other user. The curation manager 212 is further configured to store the summary, the one or more criteria, and the suggested investigation step for each cluster of the plurality of clusters in a curated query repository 224 of the computing device 102 in response to receiving approval. In some embodiments, the curation manager 212 may perform reinforcement learning with human feedback based on security incident resolution data received from a user, such as a domain expert, technical lead, or other user.

The investigation manager 214 is configured to receive a security incident for investigation. This security incident includes multiple fields indicative of a potential security detection at a monitored computer system 112 or network 110. For example, the security incident may be embodied as a new detection or other newly added record to the security incident database 220. The investigation manager 214 is further configured to assign the received security incident to a cluster based on the criteria stored in the curated query repository 224, and to retrieve suggested investigation steps for the identified cluster from the curated query repository 224.

The investigation interface 216 is configured to present the received security incident and the retrieved suggested investigation step to a user. For example, the investigation interface 216 may provide an evidence viewer, investigation portal, or other interface as a web application or other interface to a security analyst or other user. In some embodiments, the investigation interface 216 may also receive investigation steps performed by the user, including security incident resolution data indicative of how a security incident was resolved, including investigation steps taken and security outcomes.

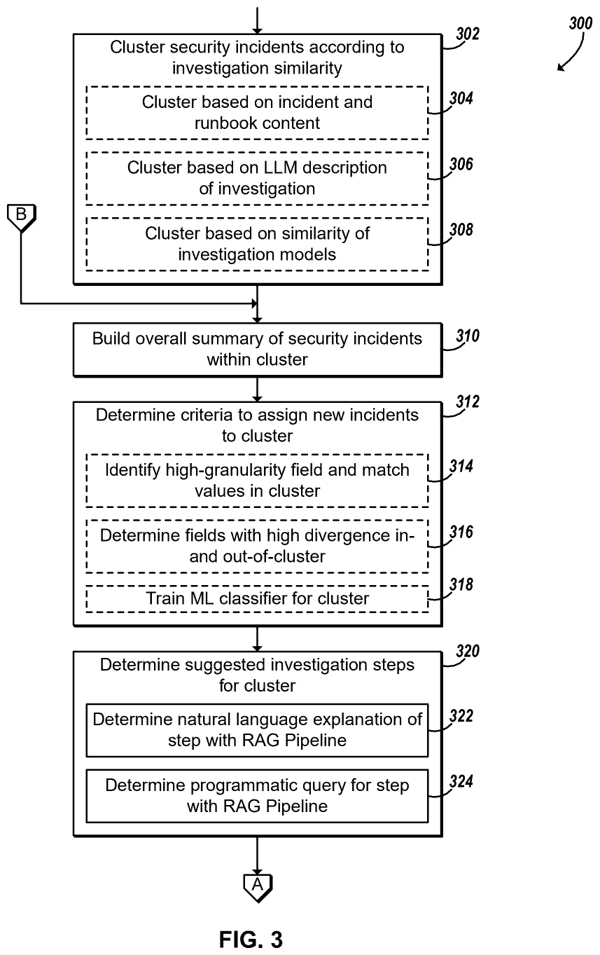

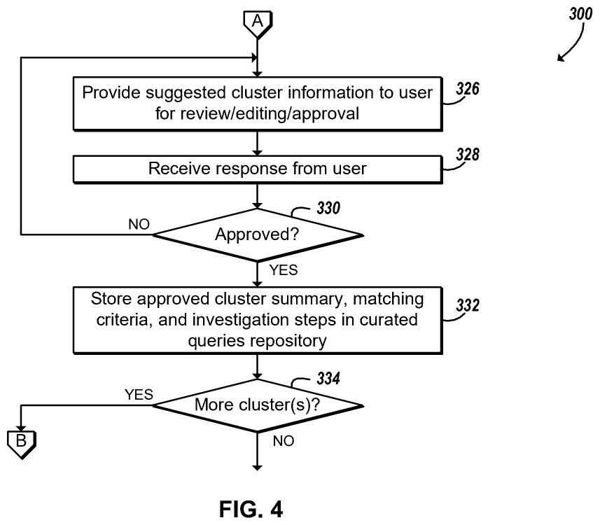

Referring now to FIGS. 3 and 4, in use, the computing device 102 may execute a method 300 for automated predictive curation of contextualization steps for investigating a security incident. It should be appreciated that, in some embodiments, the operations of the method 300 may be performed by one or more components of the environment 200 of the computing device 102 as shown in FIG. 2. The method 300 begins with block 302, in which the computing device 102 clusters security incidents according to investigation similarity. The computing device 102 may, for example, cluster historical security incidents stored in the security incident database 220. As described above, the security incident database includes fields with structured data, unstructured data, and/or other data relating to potential security incidents that occur at one or more monitored networks 110 and/or monitored devices. For example, a security incident may include data relating to host IP address, host name, timestamp, event type (e.g., login from identified country, potential exploit execution, etc.), incident severity, file name, file hash, process executable, detection rule, and/or other data. In some embodiments, the security incident may be anonymized, for example by removing or masking personally identifying information from structured data fields (e.g., host IP address, host name, user name, etc.).

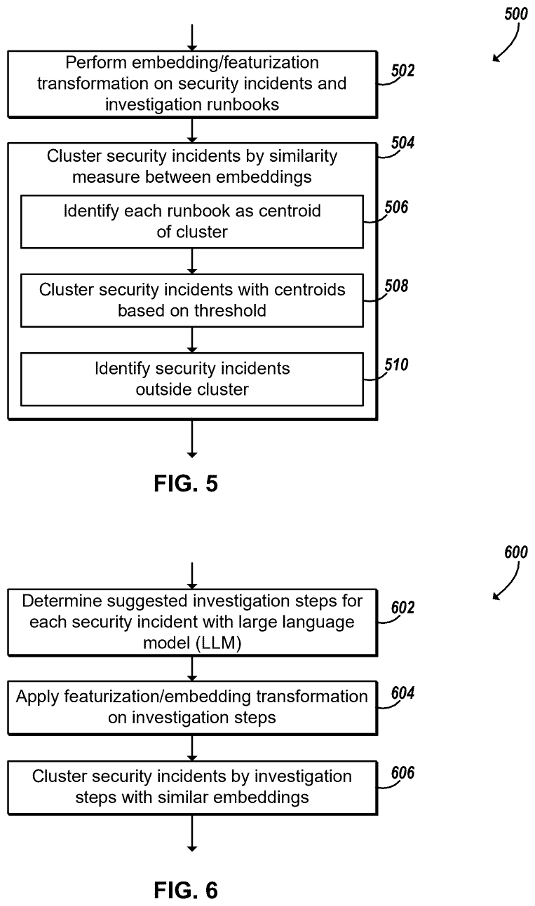

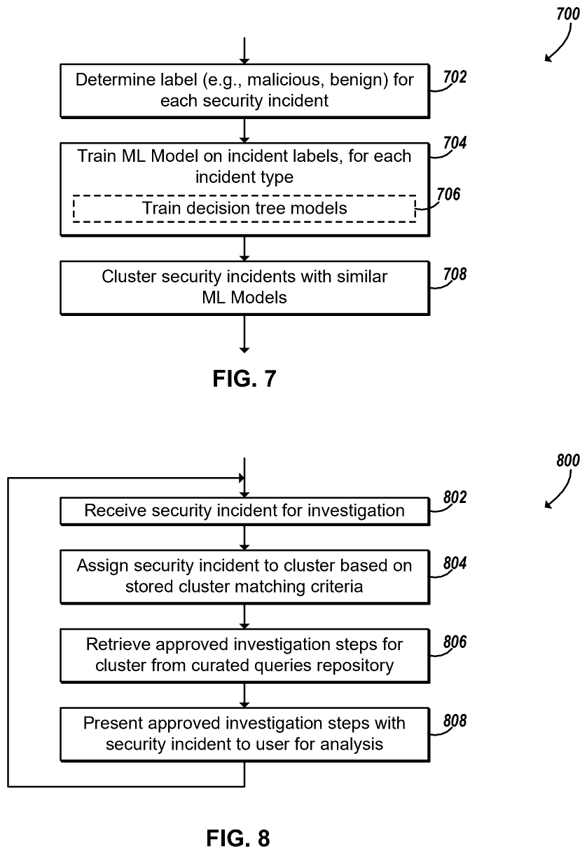

The computing device 102 clusters the security incidents according to investigation similarity such that those security incidents that have historically been investigated similarly are included in the same cluster. The computing device 102 may cluster the security incidents according to fields or other data included in the security incident, analyst notes, runbooks, and/or other data related to the security incidents and/or the investigation of the security incidents. In some embodiments, in block 304 the computing device 102 may cluster the security incidents based on content of the security incidents (e.g., one or more data fields) and runbooks. One potential embodiment of such a method for clustering security incidents is described below in connection with FIG. 5. In some embodiments, in block 306 the computing device 102 may cluster the security incidents based on an LLM-generated description of the investigation of the security incidents. One potential embodiment of such a method for clustering security incidents is described below in connection with FIG. 6. In some embodiments, in block 308 the computing device 102 may cluster the security incidents based on similarity of one or more classification models (e.g., decision tree models) used to investigate the security incidents. One potential embodiment of such a method for clustering security incidents is described below in connection with FIG. 7.

After clustering the security incidents, in block 310 the computing device 102 builds an overall summary of all security incidents included in a cluster. The computing device 102 may, for example, select an initial cluster for summarization and later iterate through all clusters as described further below. The computing device 102 may build the summary with the LLM 218, for example by prompting the LLM 218 with a description field, type field, and/or other data from all of the security incidents within the cluster.

In block 312, the computing device 102 determines criteria that may be used to assign new security incidents to the cluster. The criteria may be embodied as, for example, one or more filters on the security incident fields and values. To generate the criteria, the computing device 102 determines explainable logic for assigning security incidents to the cluster. In some embodiments, the criteria may include values or other matching logic for one or more fields of the security incident. As described further below, this logic may be executed in real time or otherwise with reduced computational complexity as compared to other clustering techniques, such as finding a distance between the security incident and cluster centroids in feature space.

In some embodiments, in block 314 the computing device 102 may identify one or more high-granularity fields in the security incidents. High-granularity fields are fields that rarely include repeated values. For example, an incident description field may be rarely repeated. For each high-granularity field, the computing device 102 may identify all values for the high-granularity field for security incidents within the cluster. The criteria may include matching any of those values of the high-granularity fields. For example, the incident description field of a new security incident may be matched against all of the values of the high-granularity fields of security incidents in the cluster. If the incident description field matches any of those values, then the new security incident is also included in the cluster.

In some embodiments, in block 316, the computing device 102 may determine one or more fields with a high divergence between security incidents within the cluster and outside of the cluster. For example, the computing device 102 may, for each field, build a histogram for the field's values for security incidents within the cluster and for security incidents outside of the cluster. The computing device 102 measures divergence between those histograms, for example by calculating the Kullback-Leibler divergence. Fields with high divergence value may be used in the matching criteria.

In some embodiments, in block 318, the computing device 102 may train a machine learning classifier to distinguish between values of one or more fields of the security incidents within the cluster and security incidents outside of the cluster. The computing device 102 may use a machine learning classifier such as an artificial neural network, a decision tree, a support vector machine, or other machine learning classifier. In some embodiments, the computing device 102 may classify the security incidents with a large language model (LLM), small language model, or other artificial intelligence model. Optimizing an LLM for a specific task or domain such as cybersecurity may employ a layered approach involving several “training,” refinement, and adaptation techniques. Each of those techniques has a different level of complexity, customization, and compute cost. For example, training an LLM is typically an expensive operation, and thus the disclosed system may employ a pre-trained foundation model or other pretrained LLM, in combination with other less compute-intensive techniques for refining or otherwise improving performance of the LLM. Various techniques for refining LLMs as described above include prompt engineering, few-shot learning, instruction tuning, fine-tuning, and RAG-based optimization.

After determining the matching criteria, in block 320 the computing device 102 determines one or more suggested investigation steps for the cluster. The suggested investigation steps include natural language description and sample programmatic queries that may be used by an analyst to contextualize the security incident and determine whether the security incident is likely benign, malicious, or otherwise process the security incident. In block 322, the computing device 102 determines a natural language explanation of the suggested investigation step with the RAG pipeline 210. Retrieval augmented generation (RAG) is a machine learning technique in which a large language model (LLM) is used with an authoritative external source in order to generate responses that incorporate specific knowledge from that external source. To generate the suggested investigation steps, the computing device 102 uses runbook 222 data, analyst notes, or other security intelligence information associated with the cluster as the retrieval source (i.e., authoritative external source) for the RAG pipeline 210. Accordingly, the suggested investigation steps may incorporate or otherwise be based on authoritative information associated with the current cluster. In block 324, the computing device 102 determines a programmatic query for the investigation step with the RAG pipeline 210. To generate the programmatic query, the computing device 102 provides a schema or other description of one or more data sources that may be queried to contextualize the security incident. For example, the computing device 102 may provide a database schema of the security incident database 220 as the retrieval source. As another example, the computing device 102 may provide a schema for another data source such as an observation data store associated with the managed networks 110 and/or managed devices 112 (which may include additional data as compared to the security incident database 220), an external API (e.g., public malware analyzer API, customer service or issue tracking API, etc.), or other data source. The programmatic query returned by the RAG pipeline 210 may be embodied as a database query, a navigable hyperlink to access security incident data, or other programmatic query that may be executed or accessed by a user to retrieve contextualization information related to the security incident.

In block 326, shown in FIG. 4, the computing device 102 provides suggested cluster information to a user for review, editing, and/or approval. The computing device 102 may provide, for example, the cluster summary, the matching criteria for including a security incident in the cluster, and the suggested investigation steps (including the natural language description and the programmatic query) to the user for review and/or editing. For example, the computing device 102 may provide the cluster information to a domain expert or other user via a dashboard interface or other web interface. As described above, the cluster information (including summary, matching criteria, and suggested investigation steps) are all explainable and/or evaluable by a human user. Accordingly, the user may evaluate the cluster information and, after applying domain expertise, provide a response to the computing device 102. In some embodiments, the computing device 102 may use one or more metrics to prioritize review of certain clusters by the user. For example, clusters with the largest number of security incidents in the cluster may be presented for review first, as these larger clusters may have the most security impact.

In block 328, the computing device 102 receives a response from the user. The response may approve, reject, and/or modify one or more parts of the cluster information. In block 330, the computing device 102 determines whether the cluster information has been approved. If not, the method 300 loops back to block 326, in which the computing device 102 may continue to present the cluster information (i.e., with potential modifications or edits). If the cluster information is approved, the method 300 advances to block 332.

In block 332, the computing device 102 stores the approved cluster summary, matching criteria, and suggested investigation steps (including natural language description and programmatic query) in the curated queries repository 224. As described further below, the contents of the curated queries repository 224 may be used to investigate new security incidents as they are detected in the monitored networks 110 and/or monitored devices 112.

In block 334, the computing device 102 determines whether additional clusters remain. If so, the method 300 loops back to block 310, shown in FIG. 3 to continue generating approved cluster information (e.g., cluster summary, matching criteria, and suggested investigation steps) for each identified cluster. If no further clusters remain, the method 300 is completed. The computing device 102 may use the now-populated curated queries repository 224 to investigate security incidents as described below in connection with FIG. 8. Additionally or alternatively, the computing device 102 may execute the method 300 again to identify additional clusters, bifurcate existing clusters, or otherwise update clustering.

Referring now to FIG. 5, in use, the computing device 102 may execute a method 500 for clustering security incidents. The method 500 may be executed in connection with block 304 of FIG. 3, described above. It should be appreciated that, in some embodiments, the operations of the method 500 may be performed by one or more components of the environment 200 of the computing device 102 as shown in FIG. 2. The method 500 begins with block 502, in which the computing device 102 performs an embedding/featurization transformation on the security incidents and investigation runbooks (e.g., from the security incident database 220 and the runbook database 222). The featurization/embedding transformation converts the provided input data (i.e., a security incident or a runbook) into a feature vector that represents the input data, which is called an embedding. Illustratively, those generated embeddings are indicative of the content of the security incidents and the runbooks. These embeddings may be compared for similarity, for example by calculating a multidimensional distance between each of the vectors representing the embeddings. The computing device 102 may use any appropriate technique to generate embeddings for the security incidents and the runbooks.

In block 504, the computing device 102 clusters the security incidents by a similarity measure between embeddings. In block 506, the computing device 102 identifies each runbook as the centroid of an associated cluster. In other words, the embedding associated with each runbook is the centroid of an associated cluster. In block 508, the computing device 102 clusters security incidents with centroids based on a predetermined similarity threshold. For example, the computing device 102 may calculate a distance measurement between the embedding of each security incident and the centroid of each cluster. When that distance is below the predetermined threshold, the security incident is included in the associated cluster. In other words, the security incident is more similar to the centroid than a predetermined similarity threshold. In block 510, the computing device 102 may identify any remaining security incidents that remain outside of any cluster. Those security incidents may have a distance from every centroid that is above the predetermined threshold, meaning that those security incidents have a similarity that is below the similarity threshold with any of the clusters. After clustering the security incidents, the method 500 is completed. The computing device 102 may continue to generate curated queries for the clustered security incidents as described above in connection with FIGS. 3 and 4.

Referring now to FIG. 6, in use, the computing device 102 may execute a method 600 for clustering security incidents. The method 600 may be executed in connection with block 306 of FIG. 3, described above. It should be appreciated that, in some embodiments, the operations of the method 600 may be performed by one or more components of the environment 200 of the computing device 102 as shown in FIG. 2. The method 600 begins with block 602, in which the computing device 102 determines suggested investigation steps for each security incident using the LLM 218. Those investigation steps may be determined by supplying the LLM 218 with incident descriptions and/or other data associated with each of the security incidents.

In block 604, the computing device 102 applies a featurization/embedding transformation on the investigation steps associated with each security incident. As described above, the featurization/embedding transformation converts the provided input data (i.e., the suggested investigation steps) into a feature vector that represents the input data, which is called an embedding. Illustratively, those generated embeddings are indicative of the content of the suggested investigation steps (rather than the content of the security incidents themselves). These embeddings may be compared for similarity, for example by calculating a multidimensional distance between each of the vectors representing the embeddings. The computing device 102 may use any appropriate technique to generate embeddings for the suggested investigation steps.

In block 606, the computing device 102 clusters the security incidents by investigation steps with similar embeddings. The computing device 102 may determine cluster centroids and boundaries based on the embeddings associated with the natural language descriptions using any appropriate clustering algorithm. For example, the computing device 102 may cluster the security incidents with a semi-supervised clustering approach using the LLM 218. As another example, the computing device 102 may cluster the security incidents by determining a distance measurement between embeddings and comparing to a predetermined threshold. In some embodiments, the computing device 102 may compare the embeddings for similarity with embeddings generated for one or more runbooks as described above. After clustering the security incidents, the method 600 is completed. The computing device 102 may continue to generate curated queries for the clustered security incidents as described above in connection with FIGS. 3 and 4.

Referring now to FIG. 7, in use, the computing device 102 may execute a method 700 for clustering security incidents. The method 700 may be executed in connection with block 308 of FIG. 3, described above. It should be appreciated that, in some embodiments, the operations of the method 700 may be performed by one or more components of the environment 200 of the computing device 102 as shown in FIG. 2. The method 700 begins with block 702, in which the computing device 102 determines a label for each security incident. In some embodiments, the label may indicate whether the security incident was determined to be malicious or benign or otherwise describe the outcome of the investigation for that security incident.

In block 704, the computing device 102 trains a machine learning model on the security incident labels for each security incident type. The computing device 102 may train the model on how to classify a particular security incident as benign or malignant or how to otherwise investigate the security incident. In some embodiments, in block 706 the computing device 102 may train one or more decision tree models, such as a malicious security incident decision tree model.

In block 708, the computing device 102 clusters security incidents with similar machine learning models (e.g., similar decision trees). The computing device 102 may use any appropriate technique for measuring similarity of machine learning models. Those security incidents with similar decision tree models for identifying malicious or benign security incidents are likely to have similar investigations. Accordingly, clustering the security incidents by similarity of decision tree may tend to cluster security incidents by similarity of investigation. After clustering the security incidents, the method 700 is completed. The computing device 102 may continue to generate curated queries for the clustered security incidents as described above in connection with FIGS. 3 and 4.

Referring now to FIG. 8, in use, the computing device 102 may execute a method 800 for investigating a security incident with curated contextualization steps. It should be appreciated that, in some embodiments, the operations of the method 800 may be performed by one or more components of the environment 200 of the computing device 102 as shown in FIG. 2. The method 800 begins with block 802, in which the computing device 102 receives a security incident for investigation. The security incident may, for example, be generated in response to triggering one or more detection rules at a monitored network 110 or a monitored device 112, or by another security detection. The security incident may be a new record in the security incident database 220 or otherwise include similar fields and other data to the security incidents of the security incident database 220.

In block 804, the computing device 102 assigns the security incident to a cluster based on the cluster matching criteria stored in the curated queries repository 224. The cluster matching criteria may be generated, approved, and stored in the curated queries repository 224 as described above in connection with FIGS. 3 and 4. As described above, to match the security incident with the cluster, the computing device 102 may compare the values of one or more fields of the security incident to one or more stored values or other matching criteria. Matching the security incident against the matching criteria may be faster and/or more computationally efficient than other techniques for assigning the security incident to a cluster. For example, the computing device 102 may not need to featurized the security incident and generate a distance from the security incident to a cluster centroid, which may improve computational efficiency.

After assigning the security incident to a cluster, in block 806 the computing device 102 retrieves the approved investigation steps for that cluster from the curated queries repository 224. The approved investigation steps may be generated, approved, and stored in the curated queries repository 224 as described above in connection with FIGS. 3 and 4.

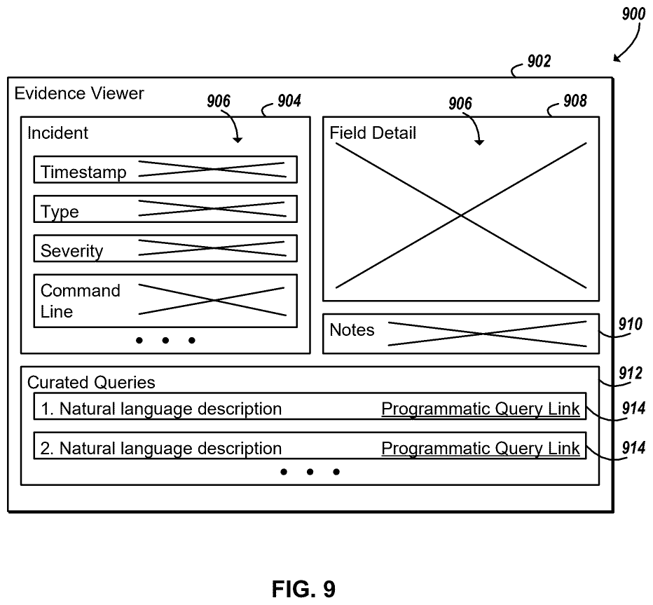

In block 808, the computing device 102 presents the approved investigation steps with the security incident to a user for analysis. For example, the computing device 102 may provide the approved investigation steps and the security incident to a security analyst or other user via a dashboard interface or other web interface. The user may investigate the security incident using the suggested investigation steps, including potentially executing or otherwise accessing the approved programmatic queries. Based on this investigation, the user may identify the security incident as benign or malicious, open a ticket for further action, or otherwise proceed with the investigation. One potential embodiment of a dashboard user interface for presenting the suggested investigation steps is shown in FIG. 9 and described further below. After presenting the approved investigation steps, the method 800 loops back to block 802, in which the computing device 102 continues processing additional security incidents.

Referring now to FIG. 9, diagram 900 illustrates a wireframe of one potential embodiment of a dashboard user interface that may be provided to a user for investigating a security incident. As shown, the user interface includes an evidence viewer 902, which may be provided by a web browser, native application, or other interactive user application. The evidence viewer 902 may be provided by the computing device 102 or otherwise capable of accessing information provided by the computing device 102.

As shown, the evidence viewer 902 includes an incident control 904 that displays information relating to a security incident currently being investigated. As shown, the incident control 904 displays the name and value of multiple fields 906 associated with the security incident. The evidence viewer 902 further includes a field detail control 908 which displays information (e.g., full information, additional details, or other information) regarding one or more selected fields 906 of the security incident. The evidence viewer 902 may also include a notes control 910, which may be used to collect analyst notes or other data relating to the security incident from the user.

The evidence viewer 902 further includes a curated queries control 912 that includes one or more curated queries 914. The curated queries 914 are associated with the cluster for the current security incident and are retrieved from the curated query repository 224 as described above in connection with FIG. 8. As shown, each curated query 914 includes a natural language description and a programmatic query link. The programmatic query link may be embodied as a hyperlink or other user interface control that, when selected by the user, allows the user to execute or otherwise access the associated programmatic query. As shown, the curated queries control 912 may display a relatively small number of curated queries for each security incident. This may allow the user to perform an efficient and effective investigation of the security incident. The user may provide data on the resolution of the security incident, including investigation steps taken and security outcomes. For example, the user may enter resolution data as natural language data in the notes field 910 or in other user interface fields.

Accordingly, a security incident or other detection (or an alert from an independent security provider) may be considered an additional piece of data updating the available information concerning a particular customer's estate. One goal of a security investigation is to identify any problems that exist in that customer's estate, using data about that customer to do so. Such an investigation should be to find out if the customer is still “all clear,” or if there are tasks that should be performed to deal with an emergent situation. Under this view, investigation steps (at least the beginning steps) may be far fewer than the actual detections/alerts, and detections may be grouped by the investigation step for a particular cluster, rather than having any kind of 1:1 relationship. And furthermore, in some embodiments, those initial investigation steps will likely lead to an even smaller number of follow-up investigation steps, which may improve investigation efficiency, accuracy, and effectiveness. In an embodiment, only a relatively small number of edge cases may remain, in which there are insufficient observed events to have high confidence on the next investigation steps. Additionally, even those edge cases may be reduced through further observations of security responses performed by human analysts.

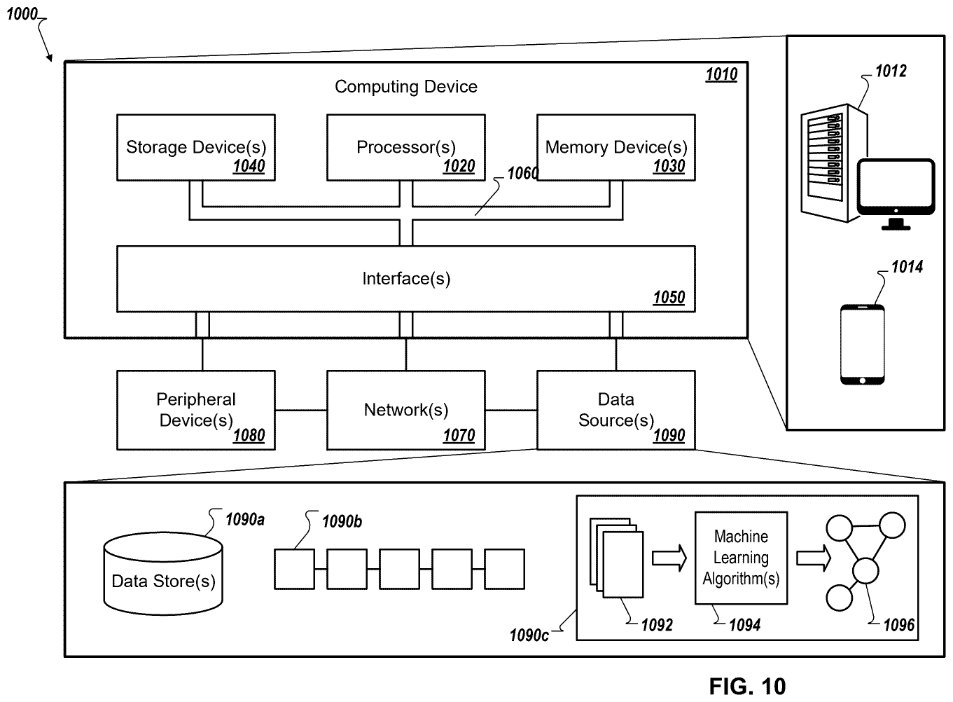

FIG. 10 is a schematic diagram that shows an example of a computing system 1000 that can be used to implement the techniques described herein. The computing system 1000 includes one or more computing devices (e.g., computing device 1010), which can be in wired and/or wireless communication with various peripheral device(s) 1080, data source(s) 1090, and/or other computing devices (e.g., over network(s) 1070). The computing device 1010 can represent various forms of stationary computers 1012 (e.g., workstations, kiosks, servers, mainframes, edge computing devices, quantum computers, etc.) and mobile computers 1014 (e.g., laptops, tablets, mobile phones, personal digital assistants, wearable devices, etc.). In some implementations, the computing device 1010 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1010, and an entire system can be made up of multiple devices communicating with each other. For example, the computing device 1010 can be part of a computing system that includes a network of computing devices, such as a cloud-based computing system, a computing system in an internal network, or a computing system in another sort of shared network. Processors of the computing device (1010) and other computing devices of a computing system can be optimized for different types of operations, secure computing tasks, etc. The components shown herein, and their functions, are meant to be examples, and are not meant to limit implementations of the technology described and/or claimed in this document.

The computing device 1010 includes processor(s) 1020, memory device(s) 1030, storage device(s) 1040, and interface(s) 1050. Each of the processor(s) 1020, the memory device(s) 1030, the storage device(s) 1040, and the interface(s) 1050 are interconnected using a system bus 1060. The processor(s) 1020 are capable of processing instructions for execution within the computing device 1010, and can include one or more single-threaded and/or multi-threaded processors. The processor(s) 1020 are capable of processing instructions stored in the memory device(s) 1030 and/or on the storage device(s) 1040. The memory device(s) 1030 can store data within the computing device 1010, and can include one or more computer-readable media, volatile memory units, and/or non-volatile memory units. The storage device(s) 1040 can provide mass storage for the computing device 1010, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1050 can include various communications interfaces (e.g., USB, Near-Field Communication (NFC), Bluetooth, WiFi, Ethernet, wireless Ethernet, etc.) that can be coupled to the network(s) 1070, peripheral device(s) 1080, and/or data source(s) 1090 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1050 can include a control interface that receives commands from an input device (e.g., operated by a user) and converts the commands for submission to the processors 1020. The interface(s) 1050 can include a display interface that includes circuitry for driving a display to present visual information to a user. The interface(s) 1050 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1070 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1010 can communicate with the peripheral device(s) 1080, the data source(s) 1090, and/or other computing devices over the network(s) 1070. In some implementations, the computing device 1010 can directly communicate with the peripheral device(s) 1080, the data source(s), and/or other computing devices.

The peripheral device(s) 1080 can provide input/output operations for the computing device 1010. Input devices (e.g., keyboards, pointing devices, touchscreens, microphones, cameras, scanners, sensors, etc.) can provide input to the computing device 1010 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1010 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1090 can provide data for use by the computing device 1010, and/or can maintain data that has been generated by the computing device 1010 and/or other devices (e.g., data collected from sensor devices, data aggregated from various different data repositories, etc.). In some implementations, one or more data sources can be hosted by the computing device 1010 (e.g., using the storage device(s) 1040). In some implementations, one or more data sources can be hosted by a different computing device. Data can be provided by the data source(s) 1090 in response to a request for data from the computing device 1010 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1090a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1090b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1090c. The machine learning system(s) 1090c, for example, can be used to analyze data from various sources (e.g., data provided by the computing device 1010, data from the data store(s) 1090a, data from the blockchain(s) 1090b, and/or data from other data sources), to identify patterns in the data, and to draw inferences from the data patterns. In general, training data 1092 can be provided to one or more machine learning algorithms 1094, and the machine learning algorithm(s) can generate a machine learning model 1096. Execution of the machine learning algorithm(s) can be performed by the computing device 1010, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents security incidents and/or investigation steps for security incidents. The machine learning model that results from the machine learning algorithm(s) can be used to cluster or otherwise classify security incidents. Use of the machine learning model can provide the benefit of accurately and/or efficiently clustering security incidents by similarity of investigation steps.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

1. A computing device for security incident analysis with adaptive incident clustering, the computing device comprising:
an incident clustering engine to cluster a plurality of security incidents and runbooks into a plurality of clusters based on investigation similarity associated with the plurality of security incidents and the runbooks;
a cluster criteria manager to determine one or more criteria for inclusion of a security incident in each cluster of the plurality of clusters, wherein each of the one or more criteria comprises explainable logic for assignment of security incidents to the associated cluster;
a retrieval augmented generation pipeline to access one or more retrieval sources for contextual awareness; and
an investigation step engine to determine a suggested investigation step for each cluster of the plurality of clusters with the retrieval augmented generation pipeline, wherein each suggested investigation step comprises a natural language description and a programmatic query of a security incident data store.

2. The computing device of claim 1, wherein each security incident of the plurality of security incidents comprises a record including a plurality of fields that are indicative of a detected computer security incident or a detected network security incident characterized by anomaly detection thresholds.

3. The computing device of claim 1, further comprising a cluster summarizer to determine, with a large language model, a summary of each cluster in the plurality of clusters based on the security incidents of the cluster.

4. The computing device of claim 1, further comprising an investigation manager to:
receive a first security incident, wherein the security incident comprises a plurality of fields indicative of a potential security detection at a monitored computer system or network;
assign the first security incident to a first cluster of the plurality of clusters based on the one or more criteria for inclusion of the security incident in each cluster of the plurality of clusters; and
retrieve a first suggested investigation step for the first cluster, wherein the first suggested investigation step was determined by the retrieval augmented generation pipeline for the first cluster.

5. The computing device of claim 4, further comprising an investigation interface to present the first security incident and the first suggested investigation step to a first user.

6. The computing device of claim 5, wherein the investigation interface is further to receive a security incident resolution from the first user, the computing device further comprising a curation manager to perform reinforcement learning with human feedback based on the security incident resolution.

7. The computing device of claim 1, wherein investigation similarity comprises vector similarity metrics and semantic proximity.

8. The computing device of claim 7, wherein to cluster the plurality of security incidents and runbooks comprises to:
generate a vector embedding for each security incident of the plurality of security incidents and for each runbook;
identify the vector embedding associated with each runbook as a centroid of a corresponding cluster; and
compare the vector embedding associated with each security incident to each of the centroids to determine an associated investigation similarity.

9. The computing device of claim 1, wherein to cluster the plurality of security incidents and runbooks comprises to:
determine a natural language description of investigation steps for each security incident with a large language model;
generate an embedding for the natural language description of investigation steps for each security incident of the plurality of security incidents; and
determine investigation similarity based on the embedding associated with the natural language description of each security incident.

10. The computing device of claim 1, wherein to cluster the plurality of security incidents and runbooks comprises to:
determine a label for each security incident of the plurality of security incidents, wherein the label comprises a benign label or a malicious label;
train a plurality of classification models on the labels associated with each of the plurality of security incidents; and
determine investigation similarity based on similarity of classification model.

11. The computing device of claim 1, wherein to determine the one or more criteria for inclusion of a security incident in the cluster comprises to:
identify a high granularity field of the plurality of security incidents; and
match against values of the high granularity field for the plurality of security incidents in the cluster.

12. The computing device of claim 1, wherein to determine the one or more criteria for inclusion of a security incident in the cluster comprises to:
determine fields of the plurality of security incidents having a high divergence between first security incidents in the cluster and second security incidents outside of the cluster; and
match against values of the fields having the high divergence.

13. The computing device of claim 1, wherein to determine the one or more criteria for inclusion of a security incident in the cluster comprises to train a machine learning classifier to classify between first security incidents in the cluster and second security incidents outside of the cluster.

14. The computing device of claim 1, wherein to determine the suggested investigation step for the cluster with the retrieval augmented generation pipeline comprises to determine the programmatic query with a schema of the security incident data store as a retrieval source of the retrieval augmented generation pipeline.

15. A method for security incident analysis with adaptive incident clustering, the method comprising:
clustering, by a computing device, a plurality of security incidents and runbooks into a plurality of clusters based on investigation similarity associated with the plurality of security incidents and the runbooks; and
for each cluster in the plurality of clusters:
determining, by the computing device, one or more criteria for inclusion of a security incident in the cluster, wherein each of the one or more criteria comprises explainable logic for assigning security incidents to the associated cluster;
accessing, by the computing device, one or more retrieval sources for contextual awareness with a retrieval augmented generation pipeline of the computing device; and
determining, by the computing device, a suggested investigation step for the cluster with the retrieval augmented generation pipeline, wherein the suggested investigation step comprises a natural language description and a programmatic query of a security incident data store.

16. The method of claim 15, further comprising, for each cluster in the plurality of clusters, determining, by the computing device with a large language model, a summary of the cluster based on the security incidents of the cluster.

17. The method of claim 15, further comprising:
receiving, by the computing device, a first security incident, wherein the security incident comprises a plurality of fields indicative of a potential security detection at a monitored computer system or network;
assigning, by the computing device, the first security incident to a first cluster of the plurality of clusters based on the one or more criteria for inclusion of the security incident in each cluster of the plurality of clusters; and
retrieving, by the computing device, a first suggested investigation step for the first cluster, wherein the first suggested investigation step was determined by the retrieval augmented generation pipeline for the first cluster.

18. The method of claim 15, wherein clustering the plurality of security incidents and runbooks comprises:
generating a vector embedding for each security incident of the plurality of security incidents and for each runbook;
identifying the vector embedding associated with each runbook as a centroid of a corresponding cluster; and
comparing the vector embedding associated with each security incident to each of the centroids to determine an associated investigation similarity.

19. The method of claim 15, wherein clustering the plurality of security incidents and runbooks comprises:
determining a natural language description of investigation steps for each security incident with a large language model;
generating an embedding for the natural language description of investigation steps for each security incident of the plurality of security incidents; and
determining investigation similarity based on the embedding associated with the natural language description of each security incident.

20. The method of claim 15, wherein clustering the plurality of security incidents and runbooks comprises:
determining a label for each security incident of the plurality of security incidents, wherein the label comprises a benign label or a malicious label;
training a plurality of classification models on the labels associated with each of the plurality of security incidents; and
determining investigation similarity based on similarity of classification model.
